(19) United States
(12) Patent Application Publication
(10) Pub. No.: US 2020/0120335 A1
(43) Pub. Date: Apr. 16, 2020

(54) AFFINE CANDIDATE DERIVATION FOR VIDEO CODING

(71) Applicant: QUALCOMM Incorporated, San Diego, CA (US)

(72) Inventors: Chao-Hsiung Hung, San Diego, CA (US); Chun-Chi Chen, San Diego, CA (US); Yu Han, San Diego, CA (US); Wei-Jung Chien, San Diego, CA (US); Marta Karczewicz, San Diego, CA (US)

(21) Appl. No.: 16/598,911

(22) Filed: Oct. 10, 2019

Related U.S. Application Data
(60) Provisional application No. 62/745,093, filed on Oct. 12, 2018.

(51) Int. Cl. H04N 19/105; H04N 19/139; H04N 19/513; H04N 19/176

(52) U.S. Cl. CPC H04N 19/105; H04N 19/176; H04N 19/513; H04N 19/139

(57) ABSTRACT

Example techniques for affine mode coding are described. A video coder may determine one or more vectors of one or more neighboring blocks that neighbor a current block, apply an offset to the one or more vectors to generate one or more refined vectors, derive one or more control point motion vectors (CPMVs) for the current block based on the one or more refined vectors, determine one or more prediction blocks based on the derived one or more CPMVs, and code the current block based on the one or more prediction blocks.

This application claims the benefit of U.S. Provisional Application No. 62/745,093, filed Oct. 12, 2018, the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for generating affine mode advanced motion vector prediction (AMVP) candidates and merge candidates in a video encoding or decoding process. The example techniques describe generating affine candidates in a plurality of example ways. The example techniques may be applied to any of the existing and developing video codecs, such as HEVC (High Efficiency Video Coding), VVC (Versatile Video Coding) or be a coding tool corresponding to any other video coding standard.

In affine mode, a current block of video data being coded (e.g., encoded or decoded) is divided into subblocks, and a video coder (e.g., video encoder or video decoder) determines motion vectors for the subblocks based on control point motion vectors (CPMVs) of control points (CPs) of the current block. The control points may be two or more corners of the current block. In some examples, the CPMVs for the current block are derived based on motion vectors of one or more neighboring blocks. In one or more examples described in this disclosure, the video coder may first determine refined motion vectors for the temporal motion vectors of the one or more neighboring blocks and then utilize the refined motion vectors for determining the CPMVs for the current block.

In one example, the disclosure describes a method of coding video data, the method comprising determining one or more vectors of one or more neighboring blocks that neighbor a current block of video data, applying an offset to the one or more vectors to generate one or more refined vectors, deriving one or more control point motion vectors (CPMVs) for the current block based on the one or more refined vectors, determining one or more prediction blocks based on the derived one or more CPMVs, and coding the current block based on the one or more prediction blocks.

In one example, the disclosure describes a device for coding video data, the device comprising a memory configured to store the video data and a processor coupled to the memory and configured to determine one or more vectors of one or more neighboring blocks that neighbor a current block of the video data, apply an offset to the one or more vectors to generate one or more refined vectors, derive one or more control point motion vectors (CPMVs) for the current block based on the one or more refined vectors, determine one or more prediction blocks based on the derived one or more CPMVs, and code the current block based on the one or more prediction blocks.

In one example, the disclosure describes a computer-readable storage medium storing instructions thereon that when executed cause one or more processors to determine one or more vectors of one or more neighboring blocks that neighbor a current block, apply an offset to the one or more vectors to generate one or more refined vectors, derive one or more control point motion vectors (CPMVs) for the current block based on the one or more refined vectors, determine one or more prediction blocks based on the derived one or more CPMVs, and code the current block based on the one or more prediction blocks.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating examples of spatial neighboring motion vector candidates for merge and advanced motion vector prediction (AMVP) modes, respectively.

FIG. 3 is a conceptual diagrams illustrating examples of a temporal motion vector predictor (TMVP) candidate and motion vector scaling for TMVP, respectively.

FIG. 4A is a conceptual diagram illustrating an example of a 4-parameter affine model.

FIG. 4B is a conceptual diagram illustrating an example of a 6-parameter affine model.

FIG. 5 is a conceptual diagram illustrating an example of an affine motion vector (MV) field per sub-block.

FIG. 6 is a conceptual diagram illustrating affine motion predictors derivation from affine motion of neighboring blocks.

FIG. 7 is a conceptual diagram illustrating affine motion predictors derivation from motion vectors of neighboring blocks.

FIG. 8 is a conceptual diagram illustrating candidate positions for affine merge mode.

FIG. 9 is a block diagram illustrating an example video encoder that may perform the techniques of this disclosure.

FIG. 10 is a block diagram illustrating an example video decoder that may perform the techniques of this disclosure.

FIG. 11 is a flowchart illustrating an example method of coding video data.

### DETAILED DESCRIPTION

As described in more detail below, the disclosure describes example techniques for determining control point motion vectors (CPMVs) for control points (CPs) of a current block of video data that is coded (e.g., encoded or decoded) in affine mode. In affine mode, the current block is coded by dividing the current block into a plurality of subblocks and performing motion compensation of each of the subblocks. To perform the motion compensation, a video coder (e.g., video encoder or video decoder) determines motion vectors for one or more of the subblocks to determine respective prediction blocks for the subblocks. In affine mode, the motion vectors for the subblocks is based on the motion vectors for the CPs of the current block (e.g., based on the CPMVs of the current block). In some examples, the CPs are two or more of the corner points of the current block. For example, the current block may be a rectangular block, and the corner points refer to the samples at corners of the rectangular block.

A video encoder may signal and a video decoder may receive information indicative of the CPMVs of the CP, and the video decoder may then determine the motion vectors for the subblocks. However, bandwidth efficiencies may be gained by having the video decoder determine the CPMVs based on motion vectors of previously decoded blocks, such as previously decoded neighboring blocks. For instance, in such examples, the video encoder need not explicitly signal the CPMVs.

In some cases, further refinements to the CPMVs may be useful so that resulting motion vectors for the subblocks, from the refined CPMVs, identify prediction blocks that are better predictors as compared to if no modifications to the CPMVs are made. Some techniques describe first determining CPMVs for the current block based on motion vectors for the previously decoded neighboring blocks and then refining the CPMVs for the current block.

However, in one or more examples described in this disclosure, a video coder may first refine the motion vectors of the previously decoded neighboring blocks, and then use the refined motion vectors to determine the CPMVs for the current block. In this way, the video coder may not need to refine the CPMVs for the current block, but instead, refine the motion vectors for the neighboring blocks and determine the CPMVs for the current block based on the refined motion vectors. Examples of the motion vectors for the neighboring blocks include the CPMVs of the neighboring blocks, if the neighboring blocks are coded in affine mode, or the motion vectors of the neighboring blocks, if the neighboring blocks are coded in inter-prediction mode (e.g., using temporal motion vectors). Another term for inter-prediction mode is inter-mode. In this disclosure inter-mode and inter-prediction mode may be used interchangeably.

Refining the motion vectors of the neighboring blocks first and then determining the CPMVs based on the refined motion vectors of the neighboring blocks for the current block may be advantageous as compared to determining the CPMVs based on motion vectors of the neighboring blocks first and then refining the CPMVs. For example, a video coder may be configured to generate a candidate list of motion vector predictors that include inherited candidates (e.g., CPMVs of neighboring blocks) and constructed candidates (e.g., temporal motion vectors of neighboring blocks). In examples where the video coder first determines the CPMVs for the current block and then refines the CPMVs for the current block, the same refinement process may be applied regardless of whether an inherited candidate or a constructed candidate is used.

However, the inherited candidates (e.g., CPMVs of neighboring blocks) and the constructed candidates (e.g., temporal motion vectors of neighboring blocks) are different types of motion vectors and derived in different ways. Accordingly, applying the same refinement process (e.g., determining by how much to offset the inherited candidates or the constructed candidates) to the inherited candidates and the constructed candidates may not necessarily result in determination of optimal CPMVs for the current block. For instance, the CPMVs derived from inherited candidates and CPMVs derived from constructed candidates may need different amounts of offset due to inherited candidates and the constructed candidates being different types. If the same offset is applied, then, in some non-limiting examples, the determined CPMVs may not be as optimal as if different offsets are applied.

Accordingly, in some examples, the video coder may be configured to perform different refinement processes (e.g., apply different offsets) based on whether an inherited candidate or constructed candidate is being used to determine the CPMVs. However, the example techniques are not so limited. The video coder need not necessarily apply different refinement processes based on whether an inherited candidate or constructed candidate is being used to determine the CPMVs.

In one or more examples described in this disclosure, the video coder may first refine the inherited candidate and the constructed candidate and then include the refined inherited candidate and the refined constructed candidate in the candidate list. In some examples, it may be possible for the video coder to utilize different refinement techniques for the inherited candidate and the constructed candidate. However, the utilization of different refinement techniques is not needed in every example.

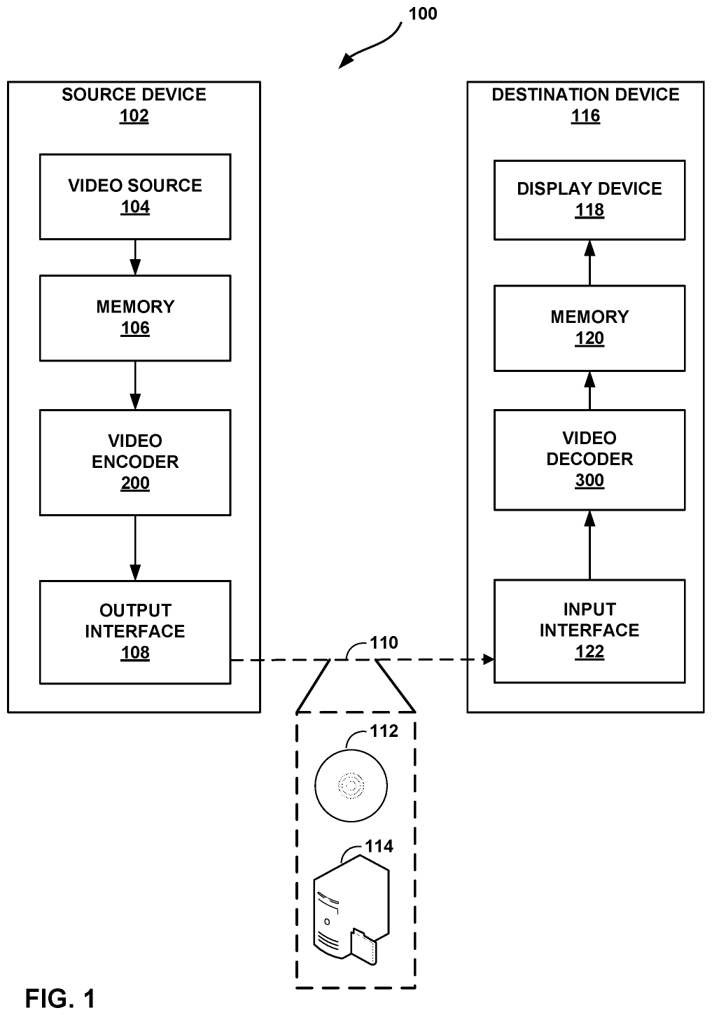

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for generating affine mode advanced motion vector prediction (AMVP) candidates and merge candidates. Thus, source device 102 represents an example of a video encoding device, while destination device 116 represents an example of a video decoding device.

In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for generating affine mode AMVP candidates and merge candidates. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may include one or both of a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Model (JEM) of the versatile video coding (VVC) standard currently under development. The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM of VVC. According to JEM, a video coder (such as video encoder 200) partitions a picture into a plurality of CTUs. Video encoder 200 may partition a CTU according to a tree structure, such as a quadtree-binary tree (QTBT) structure. The QTBT structure of JEM removes the concepts of multiple partition types, such as the separation between CUs, PUs, and TUs of HEVC. A QTBT structure of JEM includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In some examples, video encoder 200 and video decoder 300 may use a single QTBT structure to represent each of the luminance and chrominance components, while in other examples, video encoder 200 and video decoder 300 may use two or more QTBT structures, such as one QTBT structure for the luminance component and another QTBT structure for both chrominance components (or two QTBT structures for respective chrominance components).

Video encoder 200 and video decoder 300 may be configured to use quadtree partitioning per HEVC, QTBT partitioning according to JEM, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

JEM of VVC also provides an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. JEM provides sixty-seven intra-prediction modes, including various directional modes, as well as planar mode and DC mode. In general, video encoder 200 selects an intra-prediction mode that describes neighboring samples to a current block of video data (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce residual data, such as a residual block, for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values of syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As described above, video encoder 200 and video decoder 300 may be configured to predict a current block of video data in affine mode. To perform prediction in affine mode, video encoder 200 and video decoder 300 may determine control point motion vectors (CPMVs) for control points (CPs) of the current block. The CPs are generally two or more corner points of the current block (e.g., top-left corner, top-right corner, bottom-left corner, or bottom-right corner). The CPMVs are motion vectors that extend from the CPs. In affine mode, the current block is divided into a plurality of subblocks. Video encoder 200 and video decoder 300 may determine motion vectors for the subblocks based on the CPMVs using equations described in more detail below.

Video encoder 200 and video decoder 300 encode or decode the current block by encoding or decoding the subblocks based on respective motion vectors of the subblocks. For example, video encoder 200 and video decoder 300 determine respective prediction blocks for one or more of the subblocks based on respective motion vectors of the one or more subblocks. Video encoder 200 determines a residual data representing a difference between the prediction blocks and the subblocks and signals information indicative of the residual data. Video decoder 300 receives the information indicative of the residual data and adds the residual data to respective prediction blocks to reconstruct the subblocks, and in that way reconstructs the current block.

To reduce the amount of data video encoder 200 needs to signal, rather than video encoder 200 signaling the values of CPMVs for the current block, video decoder 300 may determine the values of the CPMVs based on motion vectors of neighboring blocks. In some examples, video decoder 300 may construct a candidate list of motion vectors from neighboring blocks that could be used to determine the CPMVs for the current block. The candidate list may include inherited candidates and constructed candidates. Inherited candidates refer to CPMVs of neighboring blocks, assuming neighboring blocks are coded in affine mode. However, there may be no certainty that neighboring blocks are coded in affine mode. Constructed candidates refer to temporal motion vectors (e.g., motion vectors of neighboring blocks that refer to the prediction block of the neighboring blocks). Motion vectors of neighboring blocks that refer to the prediction block of the neighboring block are referred to as temporal motion vectors of neighboring blocks.

Video encoder 200 may also construct a candidate list that includes inherited candidates and constructed candidates in the same way that video decoder 300 constructs the candidate list, such that the candidate list from video encoder 200 and the candidate list from video decoder 300 are the same candidate list. Video encoder 200 may signal an index into the candidate list, and video decoder 300 receives the index into the candidate list. Video encoder 200 and video decoder 300 may utilize the candidate identified by the index to determine the CPMVs for the current block. The candidate may be motion vector information such as CPMVs for neighboring blocks (e.g., an inherited candidate) or motion vector information such as temporal motion vectors for neighboring blocks (e.g., a constructed candidate), as two examples. It may be possible that some of the CPMVs for the current block are from an inherited candidate and other CPMVs for the current block are from a constructed candidate.

In some cases, the CPMVs for the current block may not be optimal. Accordingly, some techniques include refining the CPMVs of the current block (e.g., such as adding an offset to the CPMVs). For instance, a motion vector includes an x-component and a y-component. In some techniques, video encoder 200 and video decoder 300 may add a first offset to the x-component of the CPMVs of the current block and add a second offset to the y-component of the CPMVs of the current block. Video encoder 200 may signal information indicative of the offset, and video decoder 300 may receive the information indicative of the offset. Video encoder 200 and video decoder 300 may then utilize the refined CPMVs for the affine mode prediction of the current block.

In accordance with techniques described in this disclosure, rather than first determining the CPMV for the current block and then refining the CPMV, video encoder 200 and video decoder 300 may first refine the candidate, and then determine the CPMV for the current block based on the refined candidate. In other words, in some techniques, video encoder 200 and video decoder 300 may first determine CPMV for the current block and then refine the CPMV for the current block. In one or more examples described in this disclosure, video encoder 200 and video decoder 300 may first refine the motion vector of the neighboring block, and then use the refined motion vector of the neighboring block to determine the CPMV for the current block.

There may be various ways in which video encoder 200 and video decoder 300 may refine a motion vector of the neighboring block. As one example, video encoder 200 and video decoder 300 may first add an offset to the x- and y-component of the motion vectors of the neighboring blocks and then add the refined motion vectors of the neighboring block into the candidate lists. As another example, video encoder 200 and video decoder 300 may first select which candidate motion vector to use from the candidate list and then add an offset to the x- and y-component of the selected candidate motion vector. In both examples, video encoder 200 and video decoder 300 may use the refined motion vector of the neighboring block to determine a CPMV for the current block.

Accordingly, video encoder 200 and video decoder 300 may be configured to determine one or more vectors of one or more neighboring blocks that neighbor the current block and determine an offset to apply to the one or more vectors. The vectors may be CPMVs of the neighboring blocks or temporal motion vectors. In some examples, the one or more vectors of the one or more neighboring blocks to which video encoder 200 and video decoder 300 apply the offset may be motion vectors identified in a candidate list. Video encoder 200 and video decoder 300 may select the motion vector, to which the offset is applied, from the candidate list.

Video encoder 200 and video decoder 300 may apply the offset to the one or more vectors to generate one or more refined vectors. Video encoder 200 and video decoder 300 may derive one or more CPMVs for the current block based on the one or more refined vectors. In some examples, video encoder 200 and video decoder 300 may set the refined vectors as being equal to the CPMVs for the current block (e.g., such as in examples where affine merge is used). In some examples, video encoder 200 may signal to video decoder 300 a motion vector difference (MVD) between the actual CPMV for the current block and the refined vector. Video decoder 300 may add the MVD to the refined vector to determine the CPMV.

Video encoder 200 and video decoder 300 may determine one or more prediction blocks based on the derived one or more CPMVs. Video encoder 200 may determine residual data based on a difference between the current block and the one or more prediction blocks and signal information indicative of the residual data. Video decoder 300 may receive residual data and reconstruct the current block based on the one or more prediction blocks and the received residual data.

In some examples, adding the offset to the motion vector of the neighboring block first and then determining the CPMV for the current block may address deficiencies in techniques where the CPMV for the current block is determined first and then the CPMV for the current block is refined. As one example, in examples where the CPMV for the current block is determined first and then the CPMV for the current block is refined, the same offsets may be used regardless of whether the CPMV for the current block was determined from an inherited candidate or a constructed candidate. However, in some examples, there may be benefits of having different offsets applied to an inherited candidate or a constructed candidate.

By refining a candidate first and then using the refined candidate to define a CPMV for the current block, video encoder 200 and video decoder 300 may be configured to apply different offsets for inherited candidates (e.g., CPMVs of neighboring blocks) and constructed candidates (e.g., temporal motion vectors of neighboring blocks). For example, assume that a first vector in the candidate list is an inherited candidate and a second vector in the candidate list is a constructed candidate. In such examples, video encoder 200 and video decoder 300 may apply different offsets to the first vector and the second vector to generate, respectively, a first refined vector and a second refined vector.

In some examples, video encoder 200 and video decoder 300 may apply the offset to the vectors of the neighboring blocks (e.g., CPMVs of neighboring blocks or temporal motion vectors of neighboring blocks) as part of constructing the candidate list. For example, video encoder 200 and video decoder 300 may add a first offset for CPMVs of neighboring blocks or a second offset for temporal motion vectors of neighboring blocks. In some examples, video encoder 200 and video decoder 300 may construct the candidate list, and then determine whether a vector, selected from the candidate list, is a CPMV of a neighboring block or a temporal motion vector of a neighboring block. Based on whether the selected vector is a CPMV or a temporal motion vector, video encoder 200 and video decoder 300 may add a first offset or a second offset. The first offset and the second offset may be different or may be the same.

The following describes some techniques related to video coding, such as that of a joint exploration model (JEM): J. Chen, E. Alshina, G. J. Sullivan, J.-R. Ohm, J. Boyce, “Algorithm Description of Joint Exploration Test Model 7”, JVET-G1001, July, 2017. The JEM may be for the versatile video coding (VVC) standard. A recent draft of the VVC standard is described in Bross, et al. “Versatile Video Coding (Draft 6),” Joint Video Experts Team (JVET) of ITU-T SG 16 WP 3 and ISO/IEC JTC 1/SC 29/WG 11, 15^{th} Meeting: Gothenburg, SE, 3-12 Jul. 2019, JVET-02001-vB (hereinafter “VVC Draft 6”). The techniques of this disclosure, however, are not limited to any particular coding standard.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

An HEVC draft specification, and referred to as HEVC WD hereinafter, is available from http://phenix.intevry.fr/jct/doc_end_user/documents/14_Vienna/wg11/JCTVC-N1003-v1.zip. The latest version of the Final Draft of International Standard (FDIS) of HEVC can be found in JCTVC-L1003 v34, http://phenix.it-sudparis.eu/jct/doc_end_user/documents/12 Geneva/wg11/JCTVC-L1003-v34.zip The full citation for the HEVC specification is: TU-T H.265, Series H: Audiovisual and Multimedia Systems, Infrastructure of audiovisual services—Coding of moving video, Advanced video coding for generic audiovisual services, The International Telecommunication Union. April 2015, 634 pp. Additional information about HEVC is available from: G. J. Sullivan; J.-R. Ohm; W.-J. Han; T. Wiegand (December 2012) “Overview of the High Efficiency Video Coding (HEVC) Standard” (PDF). IEEE Transactions on Circuits and Systems for Video Technology (IEEE) 22 (12).

ITU-T VCEG (Q6/16) and ISO/IEC MPEG (JTC 1/SC 29/WG 11) studied the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Experts Team (JVET) to evaluate compression technology designs proposed by their experts in this area. The JVET first met during 19-21 Oct. 2015. A version of reference software, i.e., Joint Exploration Test Model 7 (JEM 7) could be downloaded from: https://jvet.hhi.fraunhofer.de/svn/svn_HMJEMSoftware/tags/HM-16.6-JEM-7.2/. Algorithm description of Joint Exploration Test Model 7 (JEM7) could be referred to JVET-G1001: J. Chen, E. Alshina, G. J. Sullivan, J.-R. Ohm, J. Boyce, “Algorithm Description of Joint Exploration Test Model 7”, JVET-G1001, July, 2017.

The following reviews the CU structure in HEVC. As described above, in HEVC, the largest coding unit in a slice is called a coding tree block (CTB) or coding tree unit (CTU). A CTB contains a quad-tree, the nodes of which are coding units.

The size of a CTB can be from 16×16 to 64×64 in the HEVC main profile (although technically 8×8 CTB sizes can be supported). A coding unit (CU) could be the same size of a CTB and as small as 8×8. Each coding unit is coded with one mode. When a CU is inter coded (e.g., coded in inter-prediction mode), the CU may be further partitioned into 2 or 4 prediction units (PUs) or become just one PU when further partition does not apply. When two PUs are present in one CU, the two PUs can be half size rectangles or two rectangle size with ¼ or ¾ size of the CU.

When the CU is coded in inter-prediction mode, one set of motion information is present for each PU. In addition, each PU is coded with a unique inter-prediction mode to derive the set of motion information.

The following reviews motion vector prediction. In the HEVC standard, there are two inter-prediction modes, named merge (skip is considered as a special case of merge without residual) and advanced motion vector prediction (AMVP) modes, respectively, for a prediction unit (PU).

In either AMVP or merge mode, video encoder 200 and video decoder 300 maintain a motion vector (MV) candidate list for candidates (e.g., multiple motion vector predictors). The MV candidate list is also referred to as motion vector predictor list. The motion vector(s), as well as reference indices in the merge mode, of the current PU are generated by taking one candidate from the MV candidate list. That is, video decoder 300 receives an index into the candidate list, and based on the index, selects a motion vector predictor. Video decoder 300 sets the motion vector predictor as the motion vector for the current block and utilizes the reference index into the reference picture list of the motion vector predictor as the reference index into the reference picture list for the current block.

The MV candidate list (or motion vector predictor list) includes up to 5 candidates (e.g., five motion vector predictors) for the merge mode and only two candidates (e.g., two motion vector predictors) for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, and the associated motion vectors are set as the motion vectors for the current block. However, under AMVP mode for each potential prediction direction from either list 0 or list 1, video encoder 200 explicitly signals a reference index, together with an MV predictor (MVP) index to the MV candidate list since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index. The candidates for both modes are derived similarly from the same spatial and temporal neighboring blocks.

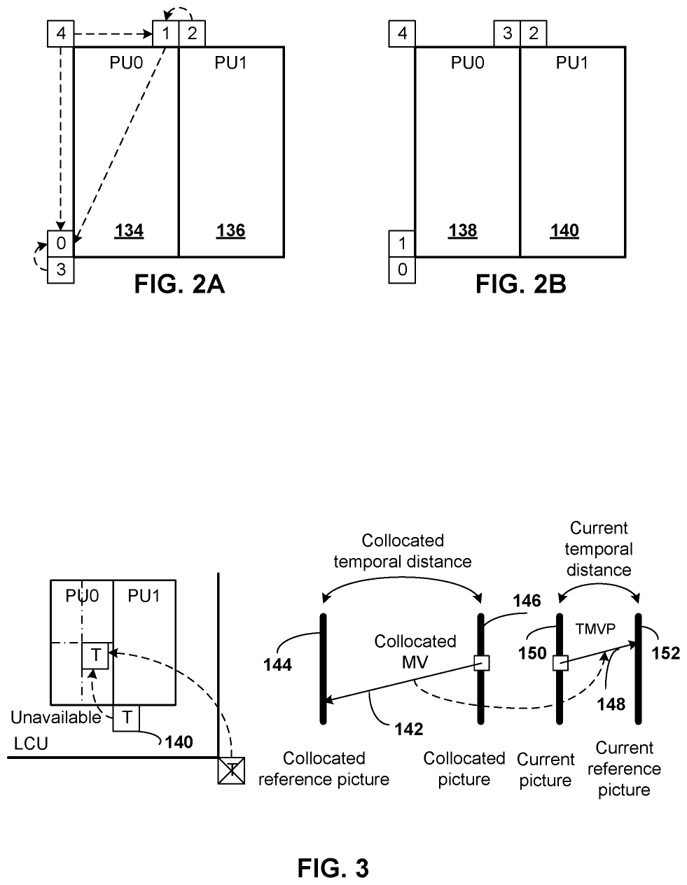

The following describes spatial neighboring candidates. In some examples, spatial MV candidates are derived from the neighboring blocks shown in FIGS. 2A and 2B, for a specific PU (PU₀) 134, although the methods for generating the candidates from the blocks differ for merge and AMVP modes.

In merge mode, in some examples, up to four spatial MV candidates can be derived with the orders shown in FIG. 2A with numbers, and the order is the following: left (0, A1), above (1, B1), above right (2, B0), below left (3, A0), and above left (4, B2), as shown in FIG. 2A. For instance, for PU0 134, block A1 is identified as 0 and is left of PU0 134, block B1 is identified as 1 and is above of PU0 134, block B0 is identified as 2 and is above right of PU0 134 and above PU1 136, block A0 is identified as 3 and is below left of PU0 134, and block B2 is identified as 4 and is above left of PU0 134.

In AVMP mode, in some examples, the neighboring blocks are divided into two groups: the left group including the block 0 and 1 that are below and left of PU0 138, respectively, and the above group including the blocks 2, 3, and 4 that are above right, above, and above left of PU01 138 as shown in FIG. 2B. Block 2 is above PU1 140. For each group, the potential candidate in a neighboring block referring to the same reference picture as that indicated by the signaled reference index has the highest priority to be chosen to form a final candidate of the group. All neighboring blocks may not contain a motion vector pointing to the same reference picture. Therefore, if such a candidate cannot be found, the first available candidate may be scaled to form the final candidate, thus the temporal distance differences can be compensated.

The following reviews temporal motion vector prediction. In some examples, a temporal motion vector predictor (TMVP) candidate, if enabled and available, is added into the MV candidate list after spatial motion vector candidates. The process of motion vector derivation for TMVP candidate is the same for both merge and AMVP modes, however the target reference index for the TMVP candidate in the merge mode is always set to 0.

In some examples, the primary block location for TMVP candidate derivation is the bottom right block outside of the collocated PU as shown in FIG. 3 as a block T 140, to compensate the bias to the above and left blocks used to generate spatial neighboring candidates. However, if that block is located outside of the current CTB row or motion information is not available, the block is substituted with a center block of the PU.

As shown in FIG. 3, a motion vector 148 for a TMVP candidate in current picture 150 is derived from the co-located PU of the collocated picture 146, indicated in the slice level. The motion vector for the co-located PU is called collocated MV 142. Similar to temporal direct mode in AVC, to derive the TMVP candidate motion vector, the collocated MV 142 may be scaled to compensate for the temporal distance differences, as shown in FIG. 3. For instance, the temporal difference between collocated picture 146 and collocated reference picture 144 and the temporal difference between current picture 150 and current reference picture 152 is used to scale collocated MV 142 to generate motion vector 148.

The following reviews some other aspects of motion prediction in HEVC. Several aspects of merge and AMVP modes are described below.

Motion Vector Scaling:

The value of motion vectors can be proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, both its associated containing picture and reference picture may be different. Therefore, a new distance (based on POC) is calculated, and the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial Motion Vector Candidate Generation:

If a motion vector candidate list is not complete (e.g., fewer candidates than a predetermined number), artificial motion vector candidates are generated and inserted at the end of the candidate list until the candidate list has all candidates. In merge mode, there are two types of artificial MV candidates: combined candidate derived only for B-slices and zero candidates used only for AMVP if the combined candidate derived only for B-slices does not provide enough artificial candidates to fill the candidate list.

For each pair of candidates that are already in the candidate list and have the necessary motion information, bi-directional combined motion vector candidates are derived by a combination of the motion vector of the first candidate referring to a picture in the list 0 and the motion vector of a second candidate referring to a picture in the list 1.

Pruning Process for Candidate Insertion:

Candidates from different blocks may happen to be the same, which decreases the efficiency of a merge/AMVP candidate list. A pruning process is applied to address this problem. The pruning process compares one candidate against the others in the current candidate list to avoid inserting identical candidates. To reduce the complexity, only a limited number of pruning processes are applied to avoid comparing each potential candidate with all the other existing candidates in the list.

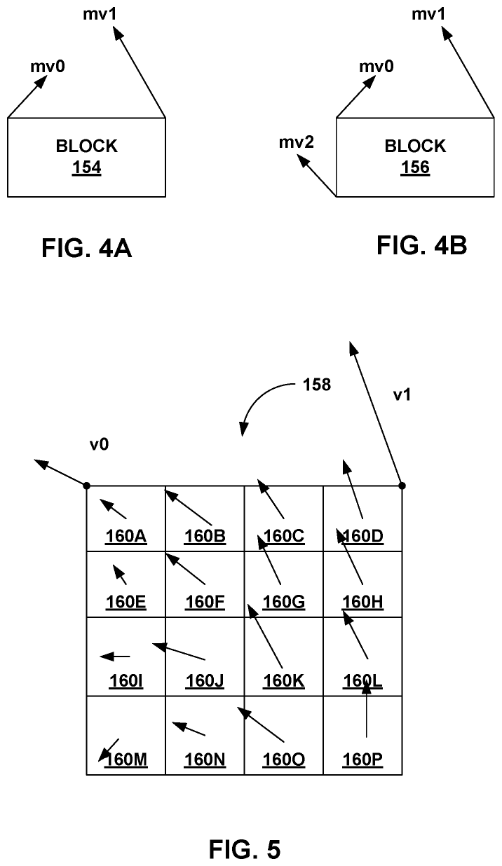

In HEVC, only a translation motion model is applied for motion compensation prediction (MCP). In the real world, however, there are many kinds of motion, e.g. zoom in/out, rotation, perspective motions and the other irregular motions. In VVC, a simplified affine transform motion compensation prediction is applied. As shown in FIGS. 4A and 4B, the affine motion field of the block is described by two or three control point motion vectors (CPMV). For example, FIG. 4A illustrates a 4-parameter affine model for block 154 with a first control point having a first motion vector mv0 and a second control point having a second motion vector mv1. The first control point is on the top-left corner of block 154, and the second control point is on the top-right corner of block 154. The mv0 and mv1 motion vectors each include an x-parameter and y-parameter. Therefore, the example of FIG. 4A is a 4-parameter affine model. The example of FIG. 4B illustrates block 156 that includes a third control point having a third motion vector mv2, which has an x-parameter and y-parameter. The third control point is on the bottom-left corner of block 156. Therefore, the example of FIG. 4B is a 6-parameter affine model.

The motion vector field (MVF) of a block of 4-parameter affine model and 6-parameter affine model is described by the following two equations. Equation 1 is for the 4-parameter affine model, and equation 2 is for the 6-parameter affine mode:

$$\begin{matrix}\{ \begin{matrix}{mv}_{x} = \frac{( {mv}_{1 x} - {mv}_{0 x} )}{w} x - \frac{( {mv}_{1 y} - {mv}_{0 y} )}{w} y + {mv}_{0 x} \\ {mv}_{y} = \frac{( {mv}_{1 y} - {mv}_{0 y} )}{w} x + \frac{( {mv}_{1 x} - {mv}_{0 x} )}{w} y + {mv}_{0 y}\end{matrix} & ( 1 ) \\ \{ \begin{matrix}{mv}_{x} = \frac{( {mv}_{1 x} - {mv}_{0 x} )}{w} x - \frac{( {mv}_{2 y} - {mv}_{0 y} )}{w} y + {mv}_{0 x} \\ {mv}_{y} = \frac{( {mv}_{1 y} - {mv}_{0 y} )}{w} x + \frac{( {mv}_{2 x} - {mv}_{0 x} )}{w} y + {mv}_{0 y}\end{matrix} & ( 2 )\end{matrix}$$

where (mv₀ₓ, mv_{0y}), (mv₁ₓ, mv_{1y}), (mv₂ₓ, mv_{2y}) are motion vectors of the top-left, top-right, and bottom-left corner control point.

In order to further simplify the motion compensation prediction, subblock based affine transform prediction with block size 4×4 may be applied. To derive motion vector of each 4×4 sub-block, the motion vector of the center sample of each subblock, as shown in FIG. 5, is calculated according to Equation (1) or (2).

For example, FIG. 5 illustrates a current block 158 having a first control point (CP) with control point motion vector (CPMV) v0, and a second CP with CPMV v1. The first CP is located at the top-left corner of current block 158, and the second CP is located at the top-right corner of current block 158.

As illustrated, current block 158 is divided into a plurality of subblocks identified as subblocks 160A-160P. Each of subblocks 160A-160P has a corresponding vector that extends from the center of respective subblocks 160A-160P. Video encoder 200 and video decoder 300 may determine the motion vectors for subblocks 160A-160P using equations (1) and (2).

The motion vector may be rounded to 1/16 fraction accuracy. After MCP (i.e., after motion compensation prediction is performed), the high accuracy motion vector of each subblock is rounded and saved as the same accuracy as the normal motion vector.

The following describes affine AMVP candidate lists. An affine AMVP candidate list can be constructed as follows and described in Y. Han, H. Huang, Y. Zhang, C. Hung, C. Chen, W. Chien and M. Karczewicz, “CE4.1.3: Affine motion compensation prediction”, JVET-K0337, July 2018.

Two candidate sets with two for 4-parameter affine model or three for 6-parameter affine model candidates {m̅v̅₀, m̅v̅₁} ({m̅v̅₀, m̅v̅₁, m̅v̅₂}) are used to predict two (for 4-parameter affine model) or three (for 6-parameter affine model) control points of the affine motion model. Given motion vector difference vectors, mvd₀, mvd₁, mvd₂, the control points are calculated:

mv₀=mv₀+mvd₀

mv₁=m̅v̅₁+mvd₁+mvd₀

mv₂=m̅v̅₂+mvd₂+mvd₀

Video encoder 200 and video decoder 300 may append sequentially to the affine candidate list to ensure that the affine candidate list is full. For example, video encoder 200 and video decoder 300 may append CPMVs from spatial neighboring blocks (extrapolated affine candidates (also called inherited candidates)), the combination of temporal motion vectors from spatial neighboring blocks (virtual affine candidates (also called constructed candidates)), and HEVC motion vector prediction (MVP) candidates until there are two candidates for 4-parameter affine model or three candidates for 6-parameter affine model affine MVPs in the candidate list. The candidate lists are constructed as follows.

In the following there is description of inherited affine candidates and constructed candidates. Inherited affine candidates mean that the control point motion vectors (CPMVs) of neighboring blocks are available to derive the CPMVs of the current block because the neighboring blocks were coded in affine mode. Constructed candidates refer to the motion vectors (e.g., temporal motion vectors) of neighboring blocks. For instance, neighboring blocks may be inter-mode coded (e.g., coded in inter-prediction mode) and therefore a motion vector is available. Since the neighboring blocks are coded in inter-prediction mode, and not affine mode, CPMVs may not be available. In some examples, the temporal motion vectors of neighboring blocks may be used for deriving the CPMVs for the current block. The examples of inherited and constructed candidates are first described with respect to AMVP and then merge mode.

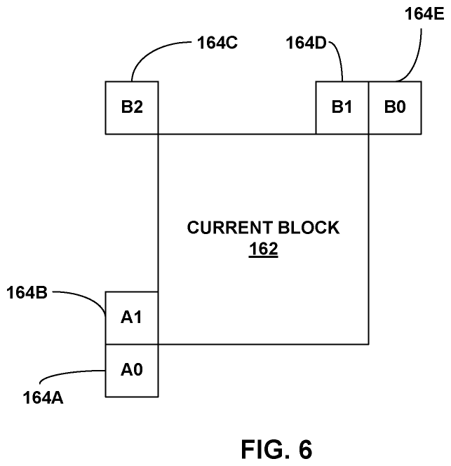

The following describes inserting inherited affine AMVP candidates. Up to two different affine MV predictor sets are derived from affine motion of the neighboring blocks. FIG. 6 illustrates current block 162. Video encoder 200 and video decoder 300 check neighboring blocks A0 164A, A1 164B, B0 164E, B1 164D, and B2 164C as shown in FIG. 6. If the neighboring block is coded using affine motion model and the reference frame of the neighboring block is the same as the reference frame of the current block 162, video encoder 200 and video decoder 300 derive MVs at two (for 4-parameter affine model) or three (for 6-parameter affine model) control points of the current block 162 from the affine model of the neighboring block. As one example, if block A0 164A is coded in affine model mode, then for a 4-parameter affine model, the two motion vectors of the two control points (like those illustrated in FIG. 4A) may be used to derive the motion vectors for the two control points of the current block 162. For a 6-parameter affine model, the three motion vectors of the three control points (like those illustrated in FIG. 4B) may be used to derive the motion vectors for the three control points of the current block 162.

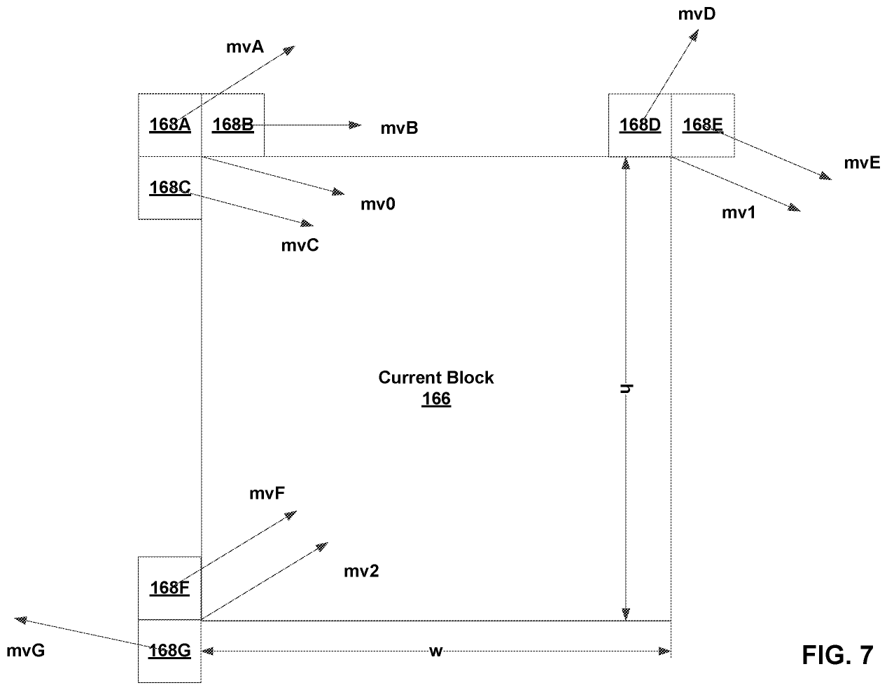

The following describes inserting constructed affine AMVP candidates. For constructed affine candidates, FIG. 7 illustrates current block 166. FIG. 7 shows the neighboring blocks of current block 166 used to generate the virtual affine candidate set. In some examples, for inserting constructed affine AMVP candidates, the AMVP candidates are generated from the motion vectors of the neighboring blocks. For instance, for the inherited affine AMVP candidates, the MVs of the control points of the neighboring blocks are used.

FIG. 7 illustrates motion vectors of neighboring blocks. For example, mv_{A} is for block 168A, mv_{B} is for block 168B, mv_{C} is for block 168C, mv_{D} is for block 168D, mv_{E} is for block 168E, mv_{F} is for block 168F, and mv_{G} is for block 168G. Also, FIG. 7 illustrates a first CP on the top-left corner of current block 166 with CPMV mv0, a second CP on the top-right corner of current block 166 with CPMV mv1, and a third CP on the bottom-left corner of current block 166 with CPMV mv2.

The neighboring MVs are divided into three groups: S₀={mv_{A}, mv_{B}, mv_{C}}, S₁={mv_{D}, mv_{E}} and S₂={mv_{F}, mv_{G}}. m̅v̅₀ is the first MV in S₀ that refers to the same reference picture as the current block 166, m̅v̅₁ is the first MV in S₁ that refers to the same reference picture of the current block 166, and m̅v̅₂ is the first in S₂ that refers to the same reference picture of the current block 166.

If only m̅v̅₀ and m̅v₁ are available, m̅v̅₂ is derived as:

$${\overline{mv}}_{2}^{x} = {\overline{mv}}_{0}^{x} - h \frac{( {\overline{mv}}_{1}^{y} - {\overline{mv}}_{0}^{y} )}{w} , {\overline{mv}}_{2}^{y} = {\overline{mv}}_{0}^{y} + h \frac{( {\overline{mv}}_{1}^{x} - {\overline{mv}}_{0}^{x} )}{w} ,$$

where the current block 166 size is W×H.

If only m̅v₀ and m̅v₂ are available, m̅v₁ is derived as:

$${\overline{mv}}_{1}^{x} = {\overline{mv}}_{0}^{x} + h \frac{( {\overline{mv}}_{2}^{y} - {\overline{mv}}_{0}^{y} )}{w} , {\overline{mv}}_{1}^{y} = {\overline{mv}}_{0}^{y} - h \frac{( {\overline{mv}}_{2}^{x} - {\overline{mv}}_{0}^{x} )}{w} .$$

The following describes affine merge candidate lists. The affine merge candidate list can be constructed using the following steps. Examples are described in H. Chen, H. Yang, and J. Chen, “CE4: Common base for affine merge mode (Test 4.2.1)”, JVET-L0366, October 2018.

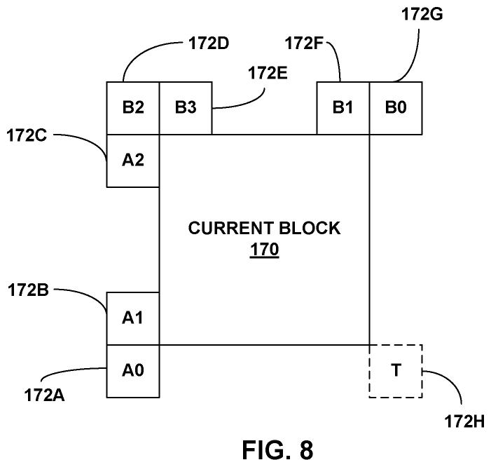

The following describes inserting inherited affine merge candidates. Inherited affine candidate means that the candidate is derived from the affine motion model of a valid neighbor affine coded block. For instance, an inherited affine candidate is a CPMV of a neighboring block that is coded in affine mode. FIG. 8 illustrates current block 170. In the common base, as shown in FIG. 8, the scan order for the candidate positions is: block A1 172B, block B1 172F, block B0 172G, block A0 172A, and block B2 172D.

After a candidate is derived, a full pruning process is performed to check whether the same candidate has been inserted into the list. If a same candidate exists in the list (e.g., has already been inserted into the list), the derived candidate is discarded.

The following describes inserting constructed affine merge candidates. If the number of candidates in the affine merge candidate list is less than maximum number of allowable affine candidates defined by MaxNumAffineCand (e.g., 5), constructed affine candidates are inserted into the candidate list. Constructed affine candidate means the candidate is constructed by combining the neighbor motion information of each control point.

The motion information for the control points is derived firstly from the specified spatial neighbors and temporal neighbor shown in FIG. 8. As described above, there may be up to four control points (e.g., one per corner of the block). The k-th control point (e.g., one of the four control points) may be represented as CPk, where CP refers to control point and k equals 1, 2, 3, or 4, each representing a corner point. Blocks A0 172A, A1 172B, A2 172C, B0 172G, B1 172F, B2 172D and B3 172E, in FIG. 8, are spatial positions for predicting CPk (k=1, 2, 3). Block T 172H is a temporal position for predicting CP4.

The coordinates of CP1, CP2, CP3 and CP4 are (0, 0), (W, 0), (0, H) and (W, H), respectively, where W and H are the width and height of current block 170. The motion information of each control point can be obtained according to the following priority order.

For CP1, the checking priority is blocks B2 172D→B3 172E→A2 172C. Block B2 172D is used if it is available. Otherwise, if block B2 172D is unavailable, block B3 172E is used. If both blocks B2 172D and B3 172E are unavailable, block A2 172C is used. If all the three candidates are unavailable, the motion information of CP1 may not be obtained. For CP2, the checking priority is blocks B1 172F→B0 172G. For CP3, the checking priority is blocks A1 172B→A0 172A. For CP4, block T 172H is used.

Secondly, the combinations of controls points are used to construct an affine merge candidate. Motion information of three control points is needed to construct a 6-parameter affine candidate. The three control points can be selected from one of the following four combinations ({CP1, CP2, CP4}, {CP1, CP2, CP3}, {CP2, CP3, CP4}, {CP1, CP3, CP4}). Combinations {CP1, CP2, CP3}, {CP2, CP3, CP4}, {CP1, CP3, CP4} may be converted to a 6-parameter motion model represented by top-left, top-right and bottom-left control points.

Motion information of two control points are needed to construct a 4-parameter affine candidate. The two control points can be selected from one of the following six combinations ({CP1, CP4}, {CP2, CP3}, {CP1, CP2}, {CP2, CP4}, {CP1, CP3}, {CP3, CP4}). Combinations {CP1, CP4}, {CP2, CP3}, {CP2, CP4}, {CP1, CP3}, {CP3, CP4} may be converted to a 4-parameter motion model represented by top-left and top-right control points.

The combinations of constructed affine candidates are inserted into the candidate list in the following order: {CP1, CP2, CP3}, {CP1, CP2, CP4}, {CP1, CP3, CP4}, {CP2, CP3, CP4}, {CP1, CP2}, {CP1, CP3}, {CP2, CP3}, {CP1, CP4}, {CP2, CP4}, {CP3, CP4}. For reference list X (X being 0 or 1) of a combination, the reference index with the highest usage ratio in the control points is selected as the reference index of list X, and motion vectors pointing to a different reference picture may be scaled.

After a candidate is derived, a full pruning process may be performed to determine whether a same candidate has been inserted into the list. If a same candidate exists, the derived candidate is discarded.

The following describes padding with zero motion vectors. If the number of candidates in affine merge candidate list is less than 5, zero motion vectors with zero reference indices are inserted into the candidate list, until the list is full.

The following describes affine merge candidate lists with prediction offset. One reference related to affine merge mode with prediction offsets is G. Li, X. Xu, X. Li, S. Liu, “CE4-related: affine merge mode with prediction offsets”, JVET-L0320, October 2018.

TABLE 1
Distance offset

| | Distance IDX | | | | |
|---|---|---|---|---|---|
| | 0 | 1 | 2 | 3 | 4 |
| distance_offset | ½- | 1- | 2- | 4- | 8- |
| | pel | pel | pel | pel | pel |

TABLE 2
direction offset

| | Offset Direction IDX | | | |
|---|---|---|---|---|
| | 00 | 01 | 10 | 11 |
| x_dir_factor | +1 | −1 | 0 | 0 |
| y_dir_factor | 0 | 0 | +1 | −1 |

In some techniques, video encoder 200 and video decoder 300 may select the first available affine merge candidate as a base predictor. In such techniques, a video coder (e.g., video encoder 200 or video decoder 300) applies a motion vector offset to a motion vector value of each control point from the base predictor. If there is no affine merge candidate available, the example techniques may not be used. The inter-prediction direction of the selected base predictor, and the reference index of each direction is used without change.

In one example, the affine model for the current block is assumed to be a 4-parameter model, and therefore, only 2 control points need to be derived. Thus, only the first 2 control points, CP1 and CP2, of the base predictor may be used as control point predictors.

For each control point, a zero_MVD flag is used to indicate whether the control point of the current block has the same MV value as the corresponding control point predictor. If zero_MVD flag is true, there is no other signaling needed for the control point. Otherwise, a distance index and an offset direction index are signaled for the control point.

A distance offset table with size of 5 is used as shown in the Table 1. The distance index is signaled to indicate which distance offset to use. The direction index can represent four directions as shown in Table 2, where only x or y direction may have an MV difference, but not in both directions.

If the inter-prediction is uni-prediction (e.g., only one temporal motion vector is used for coding according to the inter-prediction mode), the signaled distance offset is applied on the offset direction for each control point predictor. The results of these operations may be the MV value of each control point.

For example, when the base predictor is uni-prediction, the motion vector values of a control point may be CPMV(vₚₓ, v_{py}). When distance offset and direction index are signaled, the new refined control point motion vectors RCPMV(vₓ, v_{y}) of the corresponding control points of the current block corresponding block may be calculated as below:

RCPMV(vₓ,v_{y})=CPMV(vₚₓ,v_{py})+MV(x_dir_factor*distance_offset,y_dir_factor*distance_offset);

If the inter-prediction is bi-prediction (e.g., two temporal motion vectors are used for coding according to the inter-prediction mode), the signaled distance_offset is applied on the signaled offset direction for the L0 motion vector (i.e., a motion vector that points to reference picture in list 0) of the control point predictor, and the same distance_offset with opposite direction is applied for the L1 motion vector (i.e., a motion vector that points to reference picture in list 1) for the control point predictor. The results of the operations may be the refined CPMV (RCPMV) values of each control point, on each inter-prediction direction.

For example, when the base predictor is bi-prediction (e.g., two motion vectors are used for inter-prediction), the motion vector values of a control point on L0 (list 0) is CPMV_{L0} (v₀ₚₓ, v_{0py}), and the motion vector of that control point on L1 (list 1) is CPMV_{L1} (v₁ₚₓ, v_{1py}). When the distance_offset and the direction index are signaled, the refined control point motion vectors of corresponding control points for the current block may be calculated as below:

RCPMV_{L0}(v₀ₓ,v_{0y})=CPMV_{L0}(v₀ₚₓ,v_{0py})+MV(x_dir_factor*distance_offset,y_dir_factor*distance_offset);

RCPMV_{L1}(v₀ₓ,v_{0y})=CPMV_{L1}(v₀ₚₓ,v_{0py})+MV(−x_dir_factor*distance_offset,−y_dir_factor*distance_offset);

Another example with similar techniques with the following two sets of offset values is described in Y.-C. Yang, Y.-J. Chang, “CE4-related: Control point MV offset for Affine merge mode”, JVET-L0389, October 2018.

For instance, in some techniques, there may be two offset sets (Offset set 1 and Offset set 2). Both of Offset set 1 and Offset set 2 include a plurality of offset values that can be added to determine the CPMVs. One example of Offset set 1 is a set of offsets that include 8 different offset directions with 2 different offset magnitudes: Offset set 1={(4, 0), (0, 4), (−4, 0), (0, −4), (−4, −4), (4, −4), (4, 4), (−4, 4), (8, 0), (0, 8), (−8, 0), (0, −8), (−8, −8), (8, −8), (8, 8), (−8, 8)}. One example of Offset set 2 is a set of offsets that include 4 different offset directions with 1 offset magnitude: Offset set 2={(4, 0), (0, 4), (−4, 0), (0, −4)}.

Some example techniques, for affine merge candidate list with prediction offset, derive the CPMV and then add a fixed offset to determine the final CPMV. The offset may be considered as fixed offset because the same offset is applied regardless of whether the CPMV is derived from inherited candidates or constructed candidates. The inherited candidates are derived from the CPMV of spatial neighboring affine blocks. The spatial neighboring affine blocks may be blocks that are inside an affine mode block. The constructed candidates may not be CPMV from spatial neighboring affine blocks but are derived by scaling spatial neighboring MVs. Due to the different sources of the MVs, there may be potential benefits if these two types of candidates (e.g., inherited and constructed candidates) are refined using different prediction offsets.

For example, the above description described equations for RCPMV. In the above equations for RCPMV, video encoder 200 and video decoder 300 may first determine a CPMV for the current block. After determining the CPMV for the current block, video encoder 200 and video decoder 300 may refine the CPMV for the current block by adding an offset to generate the RCPMV. In some examples, the techniques for refining the CPMV are the same regardless of whether the CPMV is determined from an inherited candidate (e.g., a CPMV of a neighboring block) or a constructed candidate (e.g., temporal motion vector of a neighboring block). For instance, the same offset is added regardless of whether the inherited or constructed candidate is used. In some examples, the techniques for refining the CPMV may be different based on whether the CPMV is determined from an inherited candidate (e.g., a CPMV of a neighboring block) or a constructed candidate (e.g., temporal motion vector of a neighboring block). For instance, different offsets are added based on whether the inherited or constructed candidate is used.

The following describes example techniques to overcome technical problems described above. The example solutions may be used together or separately.

As described above, in some example techniques, the CPMVs for the current block are first derived from inherited or constructed candidates, and after derivation of the CPMVs for the current block, the offsets are added to generate the refined CPMVs. In one or more examples described in this disclosure, video encoder 200 or video decoder 300 may first add offsets to the inherited or constructed candidates to generate refined vectors. Video encoder 200 or video decoder 300 may then use the refined vectors to derive the CPMVs for the current block.

A first example technique is for a merge offset that can be added to the CPMV (control point motion vector) of a neighboring affine mode block before the CPMV of the neighboring block is used for deriving inherited candidates. For example, a merge offset MV is MV_offset(a, b) where a and b can be any positive integer value, positive fractional value, or zero. For example, when a CPMV of the neighboring affine mode block is uni-prediction, the motion vector values are CPMV(vₚₓ, v_{py}). The refined control point motion vector RCPMV(vₓ, v_{y}) for future CPMV derivation of corresponding control points for the current block may be calculated as below:

RCPMV(vₓ,v_{y})=CPMV(vₚₓ,v_{py})+MV_offset(x_dir_factor*a,y_dir_factor*b),
where x_dir_factor and y_dir_factor are +1 or −1.

For example, when a CPMV of the neighboring affine mode block is bi-prediction, the motion vector values on L0 (e.g., the motion vector that points to a reference picture identified in list 0) are CPMV_{L0} (v₀ₚₓ, v_{0py}), and the motion vector values on L1 (e.g., the motion vector that points to a reference picture identified in list 1) are CPMV_{L1} (v₁ₚₓ, v_{1py}). The refined control point motion vectors for future derived CPMVs of corresponding control points of the current block may be calculated as below:

RCPMV_{L0}(v₀ₓ,v_{0y})=CPMV_{L0}(v₀ₚₓ,v_{0py})+MV_offset(x_dir_factor,*a,y_dir_factor*b);

RCPMV_{L1}(v₀ₓ,v_{0y})=CPMV_{L1}(v₀ₚₓ,v_{0py})+MV_offset(−x_dir_factor*a,−y_dir_factor*b);
where x_dir_factor and y_dir_factor are +1 or −1.

A second example technique is for a merge offset that can be added to an MV of a neighboring inter mode block (e.g., neighboring block that is inter-predicted) before the MV of the neighboring block that is inter-predicted is used for deriving constructed inherited candidates. For example, a merge offset MV is MV_offset(a, b) where a and b can be any positive integer value, positive fractional value, or zero. For example, an inter mode block can be inter mode (AMVP mode), skip mode or merge mode.

For example, when a MV of the neighboring inter mode block is uni-prediction, the motion vector value is MV(vₚₓ, v_{py}). The refined motion vector RMV(vₓ, v_{y}) for future CPMV derivation of corresponding control points of the current block may be calculated as below:

RMV(vₓ,v_{y})=MV(vₚₓ,v_{py})+MV_offset(x_dir_factor*a,y_dir_factor*b)
where x_dir_factor and y_dir_factor are +1 or −1.

For example, when a MV of the neighboring inter mode block is bi-prediction, the motion vector values on L0 (e.g., the motion vector that points to a reference picture identified in list 0) are MV_{L0} (v₀ₚₓ, v_{0py}), and the motion vector values on L1 (e.g., the motion vector that points to a reference picture identified in list 1) are MV_{L1} (v₁ₚₓ, v_{1py}). The refined motion vectors for a future derived CPMV of corresponding control points of the current block may be calculated as below:

RMV_{L0}(v₀ₓ,v_{0y})=MV_{L0}(v₀ₚₓ,v_{0py})+MV_offset(x_dir_factor*a,y_dir_factor*b);

RMV_{L1}(v₀ₓ,v_{0y})=MV_{L1}(v₀ₚₓ,v_{0py})+MV_offset(−x_dir_factor*a,−y_dir_factor*b);
where x_dir_factor and y_dir_factor are +1 or −1.

In some examples, the MV_offset(a, b) for candidates from CPMV and candidates from temporal motion vectors may be different. For example, MV_offset(a1, b1) may be used to refine a CPMV of a neighboring block and MV_offset(a2, b2) may be used to refine a temporal motion vector of a neighboring block to determine the CPMV for the current block. In some examples, at least one of a1 and a2 may be different or b1 and b2 may be different. However, it may be possible that a1 and a2 are equal and b1 and b2 are equal.

The above describes examples of how video encoder 200 and video decoder 300 may determine one or more CPMVs for the current block. For example, a video coder (e.g., video encoder 200 and video decoder 300) may construct a candidate list that includes candidates from which the CPMV for the current block is determined. In one example, the video coder may determine whether neighboring blocks are coded in affine mode. For the neighboring blocks that are coded in affine mode, the video coder may first refine the CPMVs of the neighboring blocks (e.g., based on MV_offset(a, b) as described above) that are coded in affine mode and insert the refined CPMVs of the neighboring blocks in the candidate list (e.g., as inherited candidates).

The video coder may determine whether neighboring blocks are coded in inter-mode with temporal motion vectors. For the neighboring blocks that are coded in inter-prediction mode, the video coder may first refine the temporal motion vectors of the neighboring blocks that are coded in inter-prediction mode (e.g., based on MV_offset(a, b) as described above) and insert the refined temporal motion vectors of the neighboring blocks in the candidate list (e.g., as constructed candidates). The video coder may then select a candidate from the candidate list, and use the candidate to determine the CPMV for the current block

In some examples, for the neighboring blocks that are coded in affine mode, the video coder may insert the CPMVs of the neighboring blocks that are coded in affine mode in the candidate list (e.g., as inherited candidates). For the neighboring blocks that are coded in inter-prediction mode, the video coder may insert the temporal motion vectors of the neighboring blocks that are coded in inter-prediction mode in the candidate list (e.g., as constructed candidates). The video coder may select a candidate from the candidate list, and may refine the candidate (e.g., based on MV_offset(a, b) as described above). The video coder may then use the candidate to determine the CPMV for the current block.

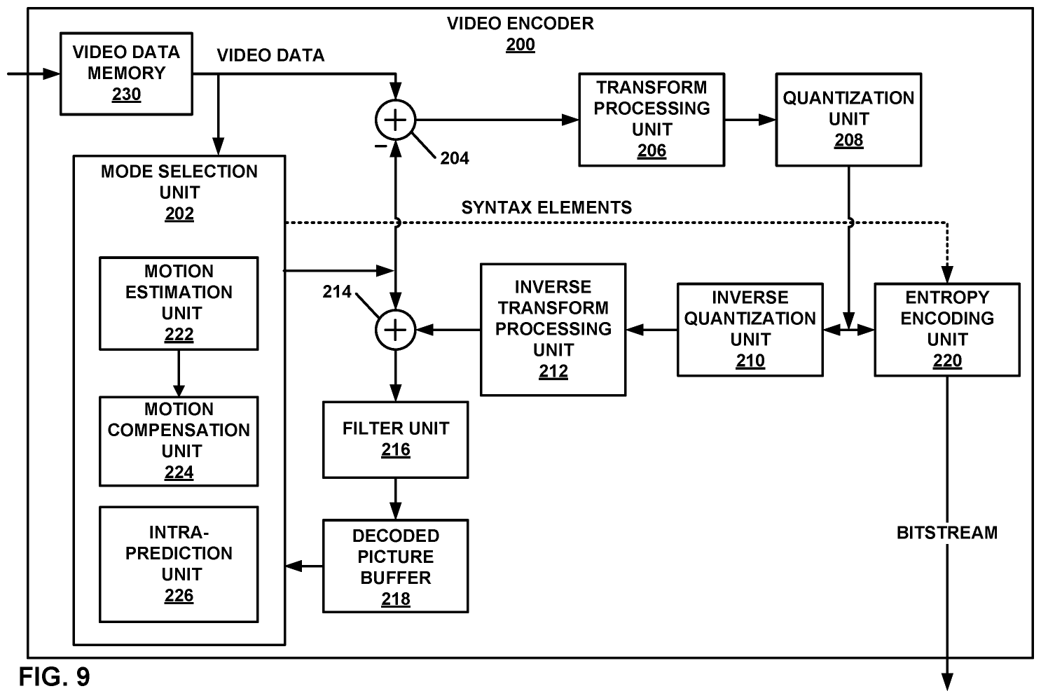

FIG. 9 is a block diagram illustrating an example video encoder 200 that may perform the techniques of this disclosure. FIG. 9 is provided for purposes of explanation and should not be considered limiting of the techniques as broadly exemplified and described in this disclosure. For purposes of explanation, this disclosure describes video encoder 200 in the context of video coding standards such as the HEVC video coding standard and the VVC video coding standard, also called the H.266 video coding standard, in development. However, the techniques of this disclosure are not limited to these video coding standards, and may be applicable generally to video encoding and decoding.

In the example of FIG. 9, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 9 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter-prediction. Video encoder 200 and video decoder 300 may also support asymmetric partitioning for PU sizes of 2N×nU, 2N×nD, nL×2N, and nR×2N for inter-prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

Video encoder 200 represents an example of a device configured to encode a video data including a memory configured to store video data, and one or more processing units implemented in circuitry and configured to determine one or more vectors of one or more neighboring blocks that neighbors a current block of video data, determine an offset to apply to the one or more vectors, apply the offset to the one or more vectors to generate one or more refined vectors, derive one or more control point motion vectors (CPMVs) for the current block based on the one or more refined vectors, determine one or more prediction blocks based on the derived one or more CPMVs, determine residual data representing a difference between the current block and the one or more prediction blocks, and signal information indicative of the residual data.

In one example, the one or more vectors are one or more CPMVs for the one or more neighboring blocks that are encoded in affine mode. In one example, the one or more vectors are one or more motion vectors (e.g., temporal motion vectors) for the one or more neighboring blocks that are encoded in inter-mode (e.g., inter-prediction mode).

As described above, the example techniques include constructing a candidate list for AMVP and merge affine modes. In one example, video encoder 200 may add offsets to the CPMVs or motion vectors of neighboring blocks and then add the resulting refined vectors to the candidate list. In this example, the candidate list includes the refined vectors (e.g., CPMVs or motion vectors of neighboring blocks to which the offset has been added).

In one example, video encoder 200 may construct the candidate list with CPMVs or motion vectors of neighboring blocks, and then add offsets to the selected one of the CPMVs or motion vectors of the neighboring block. In this example, the candidate list includes CPMVs or motion vectors of neighboring blocks to which the offset has not been added, but the offset is added after selection of one of the CPMVs or motion vectors of the neighboring block.

As one example, to determine the one or more vectors, video encoder 200 may be configured to determine a CPMV for a first neighboring block that is encoded in affine mode and determine a motion vector for a second neighboring block that is encoded in inter-prediction mode. To apply the offset, video encoder 200 may be configured to apply a first offset to the CPMV for the first neighboring block to generate a first refined vector and apply a second offset to the motion vector for the second neighboring block to generate a second refined vector. To derive the one or more CPMVs for the current block, video encoder 200 may select one of the first refined vector or the second refined vector and derive one or more of the CPMVs for the current block based on the selected one of the first refined vector or the second refined vector. In this example, video encoder 200 may construct the candidate list so that the candidate list includes the refined vectors and signal an index into the candidate list that identifies the selected one of the first refined vector and the second refined vector.

As one example, to determine the one or more vectors, video encoder 200 may be configured to determine a CPMV for a first neighboring block that is decoded in affine mode and determine a motion vector for a second neighboring block that is decoded in inter-prediction mode. Video encoder 200 may be configured to select one of the CPMV or the motion vector. To apply the offset, video encoder 200 may be configured to apply the offset to the selected one of the CPMV or the motion vector to generate the refined vector. In this example, video encoder 200 may construct the candidate list so that the candidate list includes the vectors before offset is added and signal an index into the candidate list that identifies the CPMV for the first neighboring block or the motion vector for the second neighboring block.

In one example, to apply the offset to the one or more vectors to generate one or more refined vectors, video encoder 200 may be configured to determine a direction factor for an x-component (x_dir_factor), determine an x-offset (a), determine a direction factor for a y-component (y_dir_factor), determine a y-offset (b), determine an x-component offset based on the direction factor for the x-component and the x-offset (e.g., x_dir_factor*a or −x_dir_factor*a), determine a y-component offset based on the direction factor for the y-component and the y-offset (e.g., y_dir_factor*b or −y_dir_factor*b), add the x-component offset to one or more x-components of the one or more vectors to generate one or more x-components of the one or more refined vectors, and add the y-component offset to one or more y-components of the one or more vectors to generate one or more y-components of the one or more refined vectors.

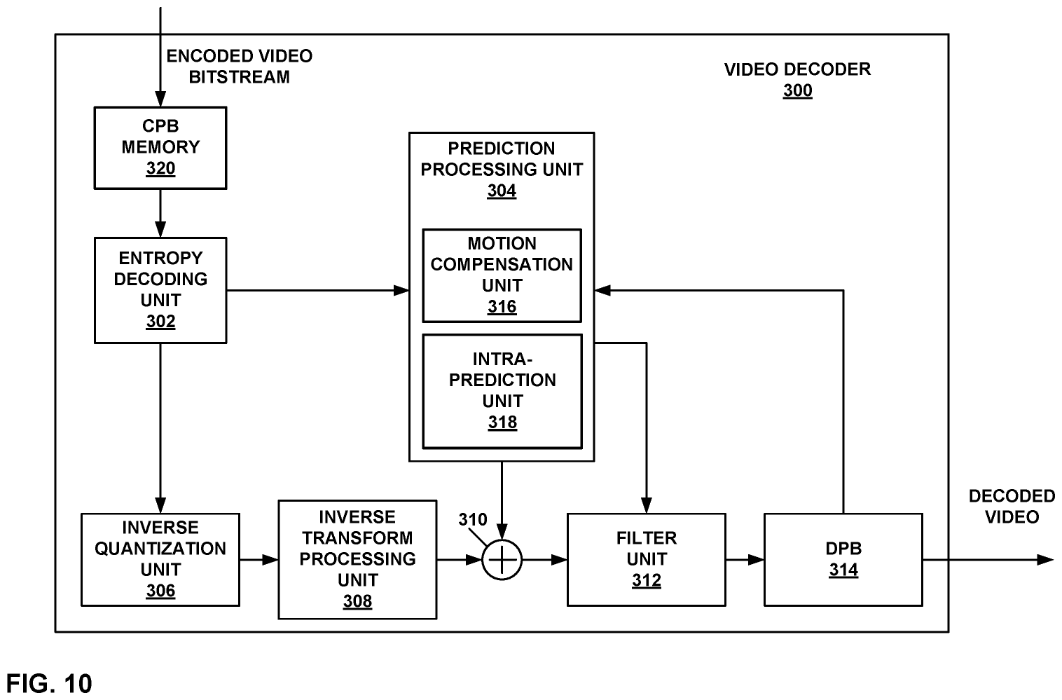

FIG. 10 is a block diagram illustrating an example video decoder 300 that may perform the techniques of this disclosure. FIG. 10 is provided for purposes of explanation and is not limiting on the techniques as broadly exemplified and described in this disclosure. For purposes of explanation, this disclosure describes video decoder 300 according to the techniques of JEM and HEVC. However, the techniques of this disclosure may be performed by video coding devices that are configured according to other video coding standards or methods.

In the example of FIG. 10, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 10 are illustrated to assist with understanding the operations performed by video decoder 300. The units may be implemented as fixed-function circuits, programmable circuits, or a combination thereof. Similar to FIG. 9, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 9).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 9). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

In this manner, video decoder 300 represents an example of a video decoding device including a memory configured to store video data, and one or more processing units implemented in circuitry and configured to determine one or more vectors of one or more neighboring blocks that neighbors a current block of video data, determine an offset to apply to the one or more vectors, apply the offset to the one or more vectors to generate one or more refined vectors, derive one or more control point motion vectors (CPMVs) for the current block based on the one or more refined vectors, determine one or more prediction blocks based on the derived one or more CPMVs, receive residual data, and reconstruct the current block based on the one or more prediction blocks and the received residual data.

In one example, the one or more vectors are one or more CPMVs for the one or more neighboring blocks that are decoded in affine mode. In one example, the one or more vectors are one or more motion vectors for the one or more neighboring blocks that are decoded in inter-prediction mode.

As described above, the example techniques include constructing a candidate list for AMVP and merge affine modes. In one example, video decoder 300 may add offsets to the CPMVs or motion vectors of neighboring blocks and then add the resulting refined vectors to the candidate list. In this example, the candidate list includes the refined vectors (e.g., CPMVs or motion vectors of neighboring blocks to which the offset has been added).

In one example, video decoder 300 may construct the candidate list with CPMVs or motion vectors of neighboring blocks, and then add offsets to the selected one of the CPMVs or motion vectors of the neighboring block. In this example, the candidate list includes CPMVs or motion vectors of neighboring blocks to which the offset has not been added, but the offset is added after selection of one of the CPMVs or motion vectors of the neighboring block.

As one example, to determine the one or more vectors, video decoder 300 may be configured to determine a CPMV for a first neighboring block that is decoded in affine mode and determine a motion vector for a second neighboring block that is decoded in inter-prediction mode. To apply the offset, video decoder 300 may be configured to apply a first offset to the CPMV for the first neighboring block to generate a first refined vector and apply a second offset to the motion vector for the second neighboring block to generate a second refined vector. To derive the one or more CPMVs for the current block, video decoder 300 is configured to select one of the first refined vector or the second refined vector and derive one or more of the CPMVs for the current block based on the selected one. In this example, video decoder 300 may construct the candidate list so that the candidate list includes the refined vectors and receive an index into the candidate list that identifies the selected one of the first refined vector or the second refined vector.

As one example, to determine the one or more vectors, video decoder 300 may be configured to determine a CPMV for a first neighboring block that is decoded in affine mode and determine a motion vector for a second neighboring block that is decoded in inter-prediction mode. Video decoder 300 may be configured to select one of the CPMV or the motion vector. To apply the offset, video decoder 300 may be configured to apply the offset to the selected one of the CPMV or the motion vector to generate the refined vector. In this example, video decoder 300 may construct the candidate list so that the candidate list includes the vectors before offset is added and receive an index into the candidate list that identifies the CPMV for the first neighboring block or the motion vector for the second neighboring block.

In one example, to apply the offset to the one or more vectors to generate one or more refined vectors, video decoder 300 may be configured to determine a direction factor for an x-component (x_dir_factor), determine an x-offset (a), determine a direction factor for a y-component (y_dir_factor), determine a y-offset (b), determine an x-component offset based on the direction factor for the x-component and the x-offset (e.g., x_dir_factor*a or −x_dir_factor*a), determine a y-component offset based on the direction factor for the y-component and the y-offset (e.g., y_dir_factor*a or −y_dir_factor*b), add the x-component offset to one or more x-components of the one or more vectors to generate one or more x-components of the one or more refined vectors, and add the y-component offset to one or more y-components of the one or more vectors to generate one or more y-components of the one or more refined vectors.

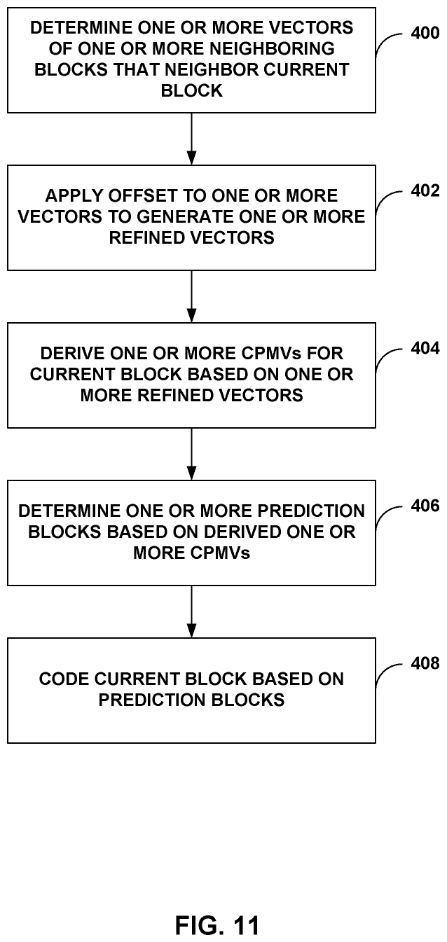

FIG. 11 is a flowchart illustrating an example method of coding video data. The example of FIG. 11 is described with respect to a video coder. The video coder may be video encoder 200 or video decoder 300. In some examples, the video coder may be a processor that includes fixed-function and/or programmable circuitry. For example, the processor may be hardwired to perform the operations of video encoder 200 or video decoder 300. The processor may execute software to perform the operations of video encoder 200 or video decoder 300. In some examples, the processor may combine hardwired and software operations to perform the techniques of video encoder 200 and video decoder 300.

The processor may be configured to determine one or more vectors of one or more neighboring blocks that neighbor a current block (400). For example, the processor may evaluate the vectors of neighboring blocks to determine the one or more vectors of the one or more neighboring blocks. As one example, the processor may determine one or more CPMVs for the one or more neighboring blocks that are coded in affine mode (e.g., the one or more neighboring blocks being coded in affine mode). As another example, the processor may determine one or more temporal motion vectors for the one or more neighboring blocks that are coded in inter-prediction mode (e.g., the one or more neighboring blocks being coded in inter-prediction mode). Accordingly, in some examples, the processor may determine a CPMV for a first neighboring block that is coded in affine mode and determine a temporal motion vector for a second neighboring block that is coded in inter-prediction mode.

The processor may apply an offset to the one or more vectors to generate one or more refined vectors (402). As one example, the processor may determine a direction factor for an x-component (x_dir_factor), determine an x-offset (a), determine a direction factor for a y-component (y_dir_factor), determine a y-offset (b), determine an x-component offset based on the direction factor for the x-component and the x-offset, determine a y-component offset based on the direction factor for the y-component and the y-offset, add the x-component offset to one or more x-components of the one or more vectors to generate one or more x-components of the one or more refined vectors, and add the y-component offset to one or more y-components of the one or more vectors to generate one or more y-components of the one or more refined vectors.

As described above, the processor may determine a CPMV for a first neighboring block and a temporal motion vector for a second neighboring block. In some examples, the processor may apply a first offset to the CPMV for the first neighboring block to generate a first refined vector and apply a second offset to the temporal motion vector for the second neighboring block to generate a second refined vector. The first offset and the second offset may be different, in some examples, although the first offset and the second offset being different is not a requirement in every example.

The processor may construct a candidate list that includes the first refined vector and the second refined vector and select one of the first refined vector or the second refined vector. For example, video decoder 300 may receive an index into the candidate list that identifies one of the first refined vector or the second refined vector, and video decoder 300 may select the first refined vector or the second refined vector based on the received index. Video encoder 200 may signal an index into the candidate list that identifies the selected one of the first refined vector and the second refined vector.

In some examples, rather than first applying offsets to the CPMV for the first neighboring block and offsets to the temporal motion vector for the second neighboring block, the processor may construct a candidate list that includes the CPMV and the temporal motion vector, and select one of the CPMV or the temporal motion vector (e.g., video decoder 300 may receive an index into the candidate list that identifies one of the CPMV or the temporal motion vector, and video encoder 200 may signal an index into the candidate list that identifies the selected one of the CPMV or the temporal motion vector). The processor may then apply the offset to the selected one of the CPMV or the temporal motion vector to generate the refined vector.

The processor may derive one or more CPMVs for the current block based on the one or more refined vectors (404). As one example, the processor may set one of the refined vectors as the CPMV to derive the one or more CPMVs for the current block. As another example, the processor may determine a difference between each of the refined vectors and the actual corresponding CPMV for the current block and may add the difference to the refined vectors to derive the CPMV for the current block.

The processor may determine one or more prediction blocks based on the derived one or more CPMVs (406). For example, the processor may use the CPMVs to determine motion vectors for the one or more subblocks that the current block is divided into. Based on the motion vectors, the processor may determine the one or more prediction blocks (e.g., the motion vectors identify the prediction blocks in respective reference pictures).

The processor may code the current block based on the prediction blocks (408). For example, for video decoder 300, video decoder 300 may receive residual data representing a difference, such as difference between luma and chroma samples, between the prediction blocks and subblocks of the current block. Video decoder 300 may reconstruct the current block based on the one or more prediction blocks and the received residual data. For video encoder 200, the video encoder 200 may determine residual data representing a difference between the prediction blocks and subblocks of the current block. Video encoder 200 may signal information indicative of the residual data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining one or more vectors of one or more neighboring blocks that neighbor a current block of video data;
applying an offset to the one or more vectors to generate one or more refined vectors;
deriving one or more control point motion vectors (CPMVs) for the current block based on the one or more refined vectors;
determining one or more prediction blocks based on the derived one or more CPMVs; and
coding the current block based on the one or more prediction blocks.

2. The method of claim 1, wherein coding the current block comprises decoding the current block, and decoding the current block comprises:
receiving residual data representing a difference between the one or more prediction blocks and one or more subblocks of the current block; and
reconstructing the current block based on the one or more prediction blocks and the received residual data.

3. The method of claim 1, wherein coding the current block comprises encoding the current block, and encoding the current block comprises:
determining residual data representing a difference between one or more subblocks of the current block and the one or more prediction blocks; and
signaling information indicative of the residual data.

4. The method of claim 1, wherein determining the one or more vectors comprises determining one or more CPMVs for the one or more neighboring blocks, the one or more neighboring blocks being coded in affine mode.

5. The method of claim 1, wherein determining the one or more vectors comprises determining one or more temporal motion vectors for the one or more neighboring blocks, the one or more neighboring blocks being coded in inter-prediction mode.

6. The method of claim 1,
wherein determining the one or more vectors comprises:
determining a CPMV for a first neighboring block that is coded in affine mode; and
determining a temporal motion vector for a second neighboring block that is coded in inter-prediction mode,
wherein applying the offset comprises:
applying a first offset to the CPMV for the first neighboring block to generate a first refined vector; and
applying a second offset to the temporal motion vector for the second neighboring block to generate a second refined vector, and
wherein deriving one or more of the CPMVs for the current block comprises:
selecting one of the first refined vector or the second refined vector; and
deriving one or more of the CPMVs for the current block based on the selected one of the first refined vector or the second refined vector.

7. The method of claim 6, further comprising:
constructing a candidate list that includes the first refined vector and the second refined vector; and
at least one of:
receiving an index into the candidate list that identifies one of the first refined vector or the second refined vector, and wherein selecting the first refined vector or the second refined vector comprises selecting the first refined vector or the second refined vector based on the received index; or
signaling an index into the candidate list that identifies the selected one of the first refined vector and the second refined vector.

8. The method of claim 1,
wherein determining the one or more vectors comprises:
determining a CPMV for a first neighboring block that is coded in affine mode; and
determining a temporal motion vector for a second neighboring block that is coded in inter-prediction mode,
the method further comprising selecting one of the CPMV or the temporal motion vector;
wherein applying the offset comprises:
applying the offset to the selected one of the CPMV or the temporal motion vector to generate the refined vector.

9. The method of claim 8, further comprising:
constructing a candidate list that includes the CPMV for the first neighboring block and the temporal motion vector for the second neighboring block; and
at least one of:
receiving an index into the candidate list that identifies one of the CPMV for the first neighboring block or the temporal motion vector for the second neighboring block, wherein selecting one of the CPMV for the first neighboring block or the temporal motion vector for the second neighboring block comprises selecting one of the CPMV for the first neighboring block or the temporal motion vector for the second neighboring block based on the received index; or
signaling an index into the candidate list that identifies the selected one of the CPMV for the first neighboring block and the temporal motion vector for the second neighboring block.

10. The method of claim 1, wherein applying the offset to the one or more vectors to generate one or more refined vectors comprises:
determining a direction factor for an x-component (x_dir_factor);
determining an x-offset (a);
determining a direction factor for a y-component (y_dir_factor);
determining a y-offset (b);
determining an x-component offset based on the direction factor for the x-component and the x-offset;
determining a y-component offset based on the direction factor for the y-component and the y-offset;
adding the x-component offset to one or more x-components of the one or more vectors to generate one or more x-components of the one or more refined vectors; and
adding the y-component offset to one or more y-components of the one or more vectors to generate one or more y-components of the one or more refined vectors.

11. A device for coding video data, the device comprising:
a memory configured to store the video data; and
a processor coupled to the memory and configured to:
determine one or more vectors of one or more neighboring blocks that neighbor a current block of the video data;
apply an offset to the one or more vectors to generate one or more refined vectors;
derive one or more control point motion vectors (CPMVs) for the current block based on the one or more refined vectors;
determine one or more prediction blocks based on the derived one or more CPMVs; and
code the current block based on the one or more prediction blocks.

12. The device of claim 11, wherein to code the current block, the processor is configured to decode the current block, and wherein to decode the current block, the processor is configured to:
receive residual data representing a difference between the one or more prediction blocks and one or more subblocks of the current block; and
reconstruct the current block based on the one or more prediction blocks and the received residual data.

13. The device of claim 11, wherein to code the current block, the processor is configured to encode the current block, and wherein to encode the current block, the processor is configured to:
determine residual data representing a difference between one or more subblocks of the current block and the one or more prediction blocks; and
signal information indicative of the residual data.

14. The device of claim 11, wherein to determine the one or more vectors, the processor is configured to determine one or more CPMVs for the one or more neighboring blocks, the one or more neighboring blocks being coded in affine mode.

15. The device of claim 11, wherein to determine the one or more vectors, the processor is configured to determine one or more temporal motion vectors for the one or more neighboring blocks, the one or more neighboring blocks being coded in inter-prediction mode.

16. The device of claim 11,
wherein to determine the one or more vectors, the processor is configured to:
determine a CPMV for a first neighboring block that is coded in affine mode; and
determine a temporal motion vector for a second neighboring block that is coded in inter-prediction mode,
wherein to apply the offset, the processor is configured to:
apply a first offset to the CPMV for the first neighboring block to generate a first refined vector; and
apply a second offset to the temporal motion vector for the second neighboring block to generate a second refined vector, and
wherein to derive one or more the CPMVs for the current block, the processor is configured to:
select one of the first refined vector or the second refined vector; and
derive one or more of the CPMVs for the current block based on the selected one of the first refined vector or the second refined vector.

17. The device of claim 16, wherein the processor is configured to:
construct a candidate list that includes the first refined vector and the second refined vector; and
at least one of:
receive an index into the candidate list that identifies one of the first refined vector or the second refined vector, and wherein to select the first refined vector or the second refined vector, the processor is configured to select the first refined vector or the second refined vector based on the received index; or
signal an index into the candidate list that identifies the selected one of the first refined vector and the second refined vector.

18. The device of claim 11,
wherein to determine the one or more vectors, the processor is configured to:
determine a CPMV for a first neighboring block that is coded in affine mode; and
determine a temporal motion vector for a second neighboring block that is coded in inter-prediction mode,
wherein the processor is configured to select one of the CPMV or the temporal motion vector, and
wherein to apply the offset, the processor is configured to:
apply the offset to the selected one of the CPMV or the temporal motion vector to generate the refined vector.

19. The device of claim 18, wherein the processor is configured to:
construct a candidate list that includes the CPMV for the first neighboring block and the temporal motion vector for the second neighboring block; and
at least one of:
receive an index into the candidate list that identifies one of the CPMV for the first neighboring block or the temporal motion vector for the second neighboring block, and to select one of the CPMV for the first neighboring block or the temporal motion vector for the second neighboring block, the processor is configured to select one of the CPMV for the first neighboring block or the temporal motion vector for the second neighboring block based on the received index; or
signal an index into the candidate list that identifies the selected one of the CPMV for the first neighboring block and the temporal motion vector for the second neighboring block.

20. The device of claim 11, wherein to apply the offset to the one or more vectors to generate one or more refined vectors, the processor is configured to:
determine a direction factor for an x-component (x_dir_factor);
determine an x-offset (a);
determine a direction factor for a y-component (y_dir_factor);
determine a y-offset (b);
determine an x-component offset based on the direction factor for the x-component and the x-offset;
determine a y-component offset based on the direction factor for the y-component and the y-offset;
add the x-component offset to one or more x-components of the one or more vectors to generate one or more x-components of the one or more refined vectors; and
add the y-component offset to one or more y-components of the one or more vectors to generate one or more y-components of the one or more refined vectors.

21. The device of claim 11, wherein the device is a wireless communication device.

22. A computer-readable storage medium having stored thereon instructions that, when executed, cause one or more processors to:
determine one or more vectors of one or more neighboring blocks that neighbor a current block;
apply an offset to the one or more vectors to generate one or more refined vectors;
derive one or more control point motion vectors (CPMVs) for the current block based on the one or more refined vectors;
determine one or more prediction blocks based on the derived one or more CPMVs; and
code the current block based on the one or more prediction blocks.

23. The computer-readable storage medium of claim 22, wherein the instructions that cause the one or more processors to code the current block comprise instructions that cause the one or more processors to decode the current block, and wherein the instructions that cause the one or more processors to decode the current block comprise instructions that cause the one or more processors to:
receive residual data representing a difference between the one or more prediction blocks and one or more subblocks of the current block; and
reconstruct the current block based on the one or more prediction blocks and the received residual data.

24. The computer-readable storage medium of claim 22, wherein the instructions that cause the one or more processors to code the current block comprise instructions that cause the one or more processors to encode the current block, and wherein the instructions that cause the one or more processors to encode the current block comprise instructions that cause the one or more processors to:
determine residual data representing a difference between one or more subblocks of the current block and the one or more prediction blocks; and
signal information indicative of the residual data.
